(19) United States
(12) Patent Application Publication
(10) Pub. No.: US 2025/0244610 A1
(43) Pub. Date: Jul. 31, 2025

(54) EYEWEAR ATTACHMENT SYSTEM

(71) Applicant: Vontélle, LLC, Brooklyn, NY (US)

(72) Inventors: Nancey Flowers-Harris, New York City, NY (US); Tracy V. Green, New York City, NY (US)

(73) Assignee: Vontélle, LLC, Brooklyn, NY (US)

(21) Appl. No.: 18/425,386

(22) Filed: Jan. 29, 2024

(51) Int. Cl. G02C 5/02

(52) U.S. Cl. CPC G02C 5/02; G02C 2200/02

(57) ABSTRACT

A lens attachment and base eyewear system includes a magnetic flip structure for an external sunglass attachment. In the attachment, two side magnets dimensioned to approximately match the width of a mating eyewear frame location are disposed on each side (a total of four), and provide planar attachment to front ferrous surfaces of those frame locations (flipped down configuration). In the center there is an L-shaped piece with two rectangle magnets on a front inside plane, and two different rectangle magnets on a bottom inside plane that is perpendicular to the front inside plane.

### FIELD OF THE INVENTION

The present invention relates to eyewear, and particularly to an attachment system for an auxiliary lens assembly.

### BACKGROUND OF THE INVENTION

Eyewear includes both prescription and nonprescription glasses (frames and lenses). Owners of prescription pairs of everyday glasses often desire sun protection. They must typically purchase a prescription pair of sunglasses to meet that need. Rather than own multiple glasses, sometimes owners of prescription lenses opt for an attachment to go onto their clear lens pair. Sun protection lens attachments typically include a bracket or clip. Such attachments may also include a mechanism enabling flip-up during use, involving cams and/or springs to enable the sun protection lenses to rotate up about 90 degrees while the attachment is still being worn. Such clip, cam and/or spring assemblies can be bulky, unsightly and uncomfortable. Since they involve moving mechanisms, they are also prone to breakage.

Using magnets in an auxiliary lens piece to flip up and down is known. U.S. Pat. No. 7,114,806 describes an eyeglass assembly with a removable auxiliary eyeglasses attachment. A magnetic hinge allows pivoting up and down, and allows removal at will, solving some of the need described above. Embodiments involve either (a) sandwiching a magnet on the auxiliary piece between two others to form a left hinge above the left lens, and doing the same to form a right hinge above the right lens, with a magnetic nosepiece on both pieces to secure the down position; or (b) using solely a nosepiece-to-nosepiece magnetic coupling of two alternate shapes to connect the two pieces. It will be noted that the first described embodiment lacks any flip-up biasing, relying on the strength of magnetic flux to hold a particular rotation angle. And the second embodiments only attach at a nosepiece, and do so with bulky exposed magnets that do not appear to constrain twisting motions that might misalign the lenses. No embodiment describes magnetic attachments at both a nosepiece and respective lens locations.

U.S. Pat. No. 6,939,003 describes a detachable magnetic hinge system in a universal eyeglass attachment. A coupling on above each lens of the auxiliary piece contains two magnets, attachably mating to any pair of four spaced magnets in an angled piece attached at corresponding places in the original frame, and permitting flip-up or flip-down biasing. In a different embodiment, a single nosepiece member on each piece has a multifaceted shape (e.g. a hexagonal cylinder), to allow coupling of an open-jaw shape on the auxiliary piece, with magnetic biasing at multiple potential flip angles. No embodiment describes magnetic attachments at both a nosepiece and respective lens locations.

U.S. Pat. No. 6,488,372 describes a flippable dual-position auxiliary lens using magnetic coupling at the bridge (nosepiece). A pair of magnets is placed in a first bar at the bridge. A second bar on the auxiliary piece has an L-shaped design permitting two positions for the auxiliary glasses depending on which arm of the L-shaped second bar is aligned with the magnets on the first bar. As above, no embodiment describes magnetic attachments at both a nosepiece and respective lens locations.

What is needed is an attachment mechanism that avoids the need for clips, cams and/or springs to enable a flip-up rotation of a sun protection lens assembly. Such mechanism should be resistant to breakage from wear, allow for stable attachment during the flipped-down state, allow for stable attachment during the flipped-up state, yet be easy to apply and remove as the wearer intends.

### SUMMARY OF THE INVENTION

In view of the above, one object of the present invention is to overcome the inherent instability and lens-misalignment risk of prior auxiliary lens magnetic attachment structures.

In accordance with this and other objects, the present invention is directed to a lens attachment and base eyewear system that advantageously includes a magnetic flip structure for an external sunglass attachment. In the attachment, two side magnets dimensioned to approximately match the width of a mating eyewear frame location are disposed on each side (a total of four) and provide planar attachment to front ferrous surfaces of those frame locations (flipped down configuration). In the center there is an L-shaped piece with two long rectangle magnets on a front inside plane, and two different long rectangle magnets on a bottom inside plane that is perpendicular to the front inside plane. In the base eyewear, ferrous material as just mentioned exists on the front to attach the side magnet pairs, to disengage during a flip-up. In the center top at the bridge/nosepiece, two rectangle magnets are oppositely poled (to attract) the attachment's center magnet pairs. With the attachment flipped-down, they attract the L-shaped piece magnets on the bottom inside plane, and flipped up, they attract the L-shaped piece magnets that are lodged on the front inside plane.

### BRIEF DESCRIPTION OF THE DRAWINGS

FIG. 1 shows a front view of an eyewear attachment system, auxiliary lenses flipped down.

FIG. 2 shows a front view of an eyewear attachment system, auxiliary lenses flipped up.

FIG. 3 shows a rear bottom view of an eyewear attachment system, auxiliary lenses flipped down.

FIG. 4 is a partial exploded view of an eyewear attachment system, separately depicting the original eyewear and the auxiliary attachment.

### DETAILED DESCRIPTION OF THE PREFERRED EMBODIMENTS

It is to be understood that the embodiments described below are by way of illustration only and not intended to limit the scope of rights to the invention, which is defined by the appended claims and equivalents thereof.

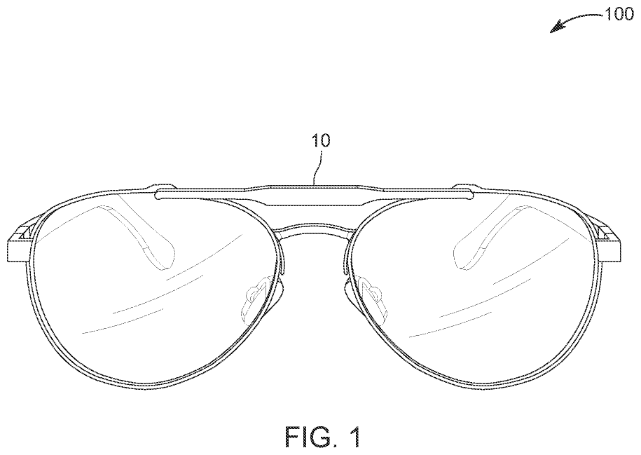

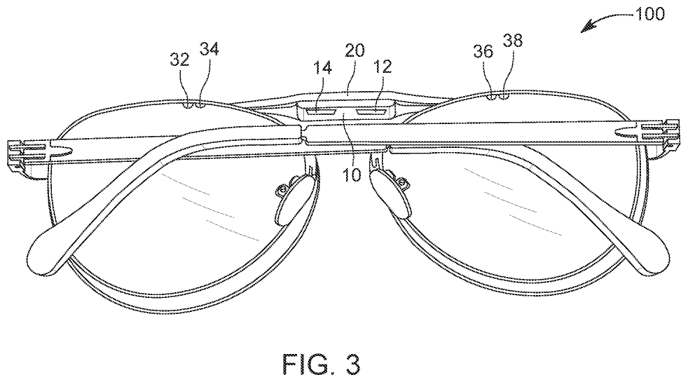

As set forth in FIGS. 1-3, the present invention relates to an eyewear attachment system 100. Eyewear 40 serves as the basic pair of eyewear on which an auxiliary attachment 30 may be secured. Eyewear 40 may be, but is not required to be, prescription eyewear comprising clear lenses. Auxiliary attachment 30 may, but is not required to, comprise sun protection lenses. It is anticipated that in conventional use, eyewear attachment system 100 will involve placement of nonprescription sun protection lenses in alignment with and over clear prescription lenses.

Within eyewear 40, bridge 20 comprises a central bar that crosses between upper portions of the left and right eyewear lenses. Bridge 20 includes insets for flush placement of magnets 22, 24, which may be cubic rectangular magnets as depicted in the figures. Insets for magnets 22, 24 may comprise the entire height of such magnets and apertures on both top and bottom, such that the magnetic surface of both top and bottom of magnets 22, 24 are exposed and bare. While FIGS. 1-3 depict bridge 20 existing in an original construction, it is also contemplated herein that bridge 20 may comprise a separately-attachable piece that will universally attach to any pre-existing pair of eyewear, such as in manners described in U.S. Pat. No. 6,939,003 (incorporated herein by reference).

With reference to FIGS. 1-4, within auxiliary attachment 30, bar 10 has a length with a front and back. The length of bar 10 has two outer edges. Each outer edge at the back secures a respective lens (e.g., a sun protection lens). Preferably and as shown, each such lens is shaped with a small chevron bulge at the top of such lens to aid in such securement at the location where it attaches to an edge of bar 10. Securement may be through adhesive, epoxy, threaded fastener, or any other means known in the art. Whatever such means, attachment 30 further comprises respective disc magnets projecting rearward from the top of the lenses, which are magnets 32, 34 at one lens and 36, 38 at the other. Magnets 32, 34, 36, 38 project out of the rear of sun protection lenses, at the top where the outer edges of bar 10 secure such lenses. Put another way, magnets 32, 34 combine with one outer edge of bar 10 to sandwich (enclose) the top of one lens of auxiliary attachment 30, and magnets 36, 38 combine with the other outer edge of bar 10 to sandwich the top of the other lens of auxiliary attachment 30. Such magnets may be combined with the lens securement (e.g., may rest on the end of a threaded fastener), or may simply be attached to the lens at that location via adhesive or epoxy.

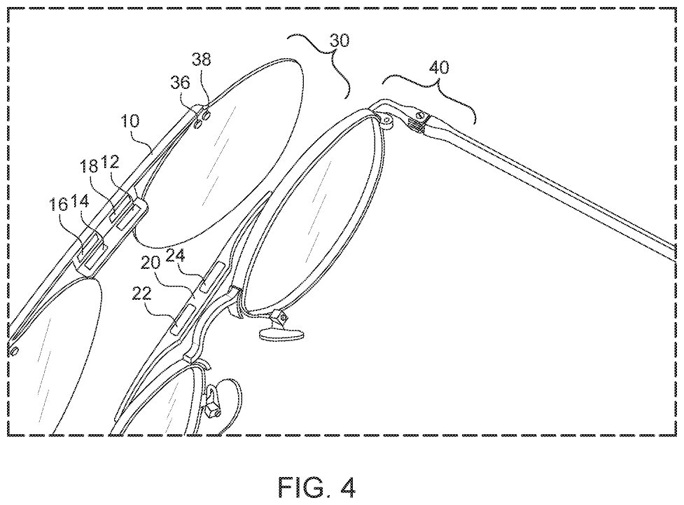

Auxiliary attachment 30 also contains an L-shaped section at the center of bar 10. The L-shaped section includes one plane that extends away from the back and bottom of bar 10, and a second plane that is on the back of bar 10 in a vertical extent. Such two planes preferably form a 90-degree angle. The L-shaped section has an enlarged height for the back plane along its extent at the center of bar 10, and preferably a backward extent of the other plane. As shown in FIG. 4, each plane of the L-shaped section contains two magnets: 12, 14 in the rearward extending plane, and 16, 18 in the back plane. These magnets are preferably rectangular of equal dimension as magnets 22, 24 in bridge 20, and are inset into the volume of the L-shape section in the same manner as discussed with respect to magnets 22, 24 in bridge 20. For all inset magnets discussed herein (12, 14, 16, 18, 22, 24), they may be secured in their insets either by mechanical bracketing of either surrounding material or a securement structure, by adhesives or epoxies, or some combination of both.

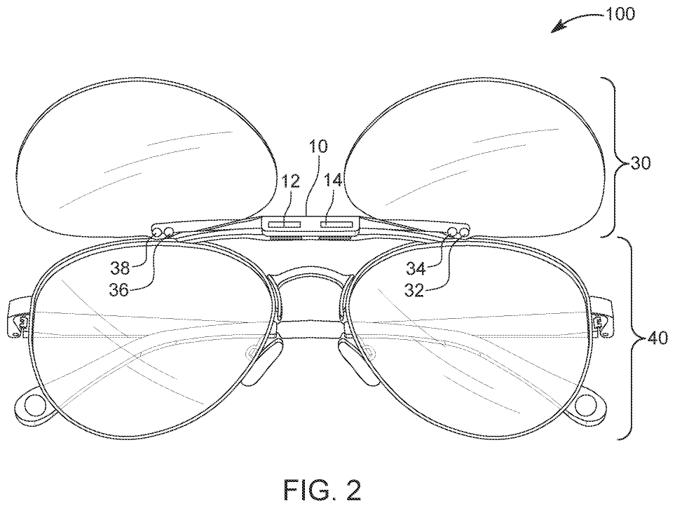

Eyewear attachment system 100 can be biased in either a flipped up or flipped down configuration. In the flipped up configuration, shown in FIG. 2, magnets 16 and 18 as exposed on the back of bar 10 (from FIG. 4) contact and adhere via magnetic force to the top of magnets 22 and 24 at the top of bridge 20, which are configured to have opposite polarity at such contacting surfaces so as to attract magnets 16 and 18 at such top. In a flipped down configuration, magnets 16 and 18 disengage and magnets 12 and 14 engage the bottom of magnets 22 and 24 at the bottom of bridge 20 (also configured to have opposite polarity at such contacting surfaces so as to attract magnets 12 and 14 at such bottom). In this flipped down configuration, it is not only magnets 12 and 14 of the auxiliary attachment 30 that engage with an attraction force. Additional magnets do as well, in a manner to guarantee continued alignment of respective lenses of eyewear 40 and auxiliary attachment 30. These are magnets 32, 34 on one side, and magnets 36, 38 on the other side, which forcibly attract ferrous material of the frames of eyewear 40 at the location where they touch. Alternatively or additionally, such frame locations may themselves contain one or more suitably poled magnets to aid or augment such attraction. In this way, magnets 32, 34, 36 and 38 aid in stabilizing auxiliary attachment 30, and preventing torsion that could result in lens misalignment or unintended detachment of auxiliary attachment 30.

As shown in FIG. 4, it will be appreciated that the foregoing structures permit easy connection and separation of auxiliary attachment 30 from eyewear 40. Thus a user of eyewear 40 may use them bare (without any attachment), or may configure them to cooperate with auxiliary attachment 30 for flipped-down sun shades or flipped-up sun shades. As a result, eyewear attachment system 100 permits attachment and detachment of auxiliary lenses, easy and securely-biased flips both up and down of such shades, all while better preserving lens alignments through additional securement means not contemplated previously in the art.

It will be appreciated that magnets discussed herein may be of any shape and size, so long as they enable the functions described herein to be performed. Preferably they are rare earth magnets (e.g., neodymium magnets), though any suitable material for such magnets may be used. It will also be appreciated that respective lenses of eyewear 40 and auxiliary attachment 30 are preferably of substantially identical shape, though this is not a requirement of the inventive concepts described herein.

It should be understood, of course, that the foregoing relates to exemplary embodiments of the invention and that modifications may be made without departing from the spirit and scope of the invention as set forth in the following claims. For example, in discussions relating to a pair of magnets, a single magnet is contemplated as within the scope of the invention. Also, discussions relating to magnet-to-magnet attraction contemplate within their scope magnet-to-ferrous-material attraction, and vice versa.

What is claimed is:

1. An eyewear system comprising:
(a) eyewear having a bridge, the bridge having at least one inset containing at least one eyewear magnet with a first exposed magnetic surface, the eyewear further comprising ferrous material in at least part of a frame;
(b) an auxiliary attachment that removably engages said eyewear, the auxiliary attachment comprising a bar having respective outer edges, each outer edge securing a top of a lens at a securement location, the auxiliary attachment further comprising at least one auxiliary magnet at each securement location that, together with the outer edge, encloses the top of respective lens of the auxiliary attachment, the auxiliary magnet configured for attractive connection to the ferrous material in the at least part of the frame;
(c) the auxiliary attachment further comprising an L-shaped section at a center of the bar, the L-shaped section comprising at least one center magnet configured for attractive connection to the first exposed magnetic surface of the bridge of the eyewear.

2. The eyewear system of claim 1, wherein the L-shaped section comprises two planes that meet at a corner, one of said two planes comprising the at least one center magnet configured for attractive connection to the at least one eyewear magnet in one of either a flipped up or flipped down state, the other of said two planes comprising a second at least one center magnet configured for attractive connection to the at least one eyewear magnet in the other of the flipped up or flipped down state.

3. The eyewear system of claim 1, wherein the at least one auxiliary magnet comprises a first pair of auxiliary magnets at one outer edge, and a second pair of auxiliary magnets at the other outer edge.

4. The eyewear system of claim 3, wherein the first pair and second pair of auxiliary magnets are respective disc magnets, of approximately equal size to match the frame width at the location of the ferrous material in the frame.

5. The eyewear system of claim 2, wherein the flipped up state comprises at least one magnet in a back plane of the L-shaped section in attractive connection to a top of the at least one eyewear magnet in the bridge.

6. The eyewear system of claim 2, wherein the flipped down state comprises at least one magnet in a rear-extending plane of the L-shaped section in attractive connection to a bottom of the at least one eyewear magnet in the bridge.

7. The eyewear system of claim 2, wherein the L-shaped section comprises a greater height than all other parts of the bar.

8. The eyewear system of claim 1, wherein said bridge is removably attachable.

9. The eyewear system of claim 1, wherein said eyewear comprises clear prescription lenses, and wherein said auxiliary attachment comprises nonprescription sun protection lenses.

10. The eyewear system of claim 1, wherein the lenses of the auxiliary attachment each comprise a bulge at which respective auxiliary magnets and outer edges enclose said lenses.
